(19) United States
(12) Patent Application Publication
(10) Pub. No.: US 2018/0084434 A1
(43) Pub. Date: Mar. 22, 2018

(54) METHOD AND APPARATUS FOR INSTALLING ANTENNA DEVICES AND GUIDING INSTALLATION

(71) Applicant: Nokia Technologies Oy, Espoo (FI)

(72) Inventors: Raimo VUONNALA, Espoo (FI); Juhani HUTTUNEN, Veikkola (FI)

(21) Appl. No.: 15/562,160

(22) PCT Filed: Apr. 10, 2015
(86) PCT No.: PCT/US15/25380

§ 371 Date: Sep. 27, 2017

(51) Int. Cl. H04W 16/18; H04W 64/00; H04W 24/02; H04W 16/28

(52) U.S. Cl. CPC H04W 16/18; H04W 16/28; H04W 24/02; H04W 64/003

(57) ABSTRACT

In accordance with an example embodiment of the present invention, an apparatus comprising: at least one processor; and at least one memory including computer program code, wherein the at least one memory and the computer program code are configured to, with the at least one processor, cause the apparatus to perform at least the following: set from one edge against a surface location, detect that the one edge of the apparatus is against the surface location, and cause an angle of the apparatus towards a base station to be measured, wherein the angle is used to determine surface location for an antenna installation.

### TECHNICAL FIELD

The subject matter described herein relates to a device with directional antenna setup.

### BACKGROUND

Wireless networks, such as 3G or 4G/LTE (long term evolution), can be used to provide customers high speed broadband services in areas where a fixed connection, such as DSL or fiber, is not possible or difficult due to reasons such as high cost. To achieve high performance, a customer premises equipment (CPE) may use a high-gain directional antenna. To point the directional antenna to the sending base station (BS), one needs to know the direction towards the best BS. Directional antenna may be manually steerable, for example, mounted to a pole, or a fixed-mounted beamforming panel antenna which can be steered electronically.

### SUMMARY

Various aspects of examples of the invention are set out in the claims.

According to a first aspect of the present invention, an apparatus comprising: at least one processor; and at least one memory including computer program code, wherein the at least one memory and the computer program code are configured to, with the at least one processor, cause the apparatus to perform at least the following: set from one edge against a surface location, detect that the one edge of the apparatus is against the surface location, and cause an angle of the apparatus towards a base station to be measured, wherein the angle is used to determine surface location for an antenna installation.

According to a second aspect of the present invention, a method comprising: setting from one edge of a measuring device against a surface location, detecting that the one edge of the measuring device is against the surface location, and cause an angle of the measuring device towards a base station to be measured, wherein the angle is used to determine surface location for an antenna installation.

According to a third aspect of the present invention, an apparatus comprising: at least one processor; and at least one memory including computer program code, wherein the at least one memory and the computer program code are configured to, with the at least one processor, cause the apparatus to perform at least the following: receive a message including an identity and location information of a device with directional antenna at least partly from a measuring device, select at least one base station based on the received message and at least one of: radio connectivity between a base station and the measuring device, and planned capacity in the location of the measuring device, send a cell identity and location information of the selected at least one base station to the measuring device; and receive at least one of: an identity of the device with directional antenna, the cell identity of the base station selected by the measuring device, and information associated with an angle between a reference line which is the selected surface location normal direction and a second line which is between the selected base station and the selected surface location.

According to a fourth aspect of the present invention, a method comprising: receiving a message including an identity and location information of a device with directional antenna at least partly from a measuring device, selecting at least one base station based on the received message and at least one of: radio connectivity between a base station and the measuring device, and planned capacity in the location of the measuring device, sending a cell identity and location information of the selected at least one base station to the measuring device; and receiving at least one of: an identity of the device with directional antenna, the cell identity of the base station selected by the measuring device, and information associated with an angle between a reference line which is the selected surface location normal direction and a second line which is between the selected base station and the selected surface location.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example network in which some example embodiments of the present invention may be practiced;

FIG. 2 illustrates an example process for installing a device with directional antenna in accordance with some example embodiments;

FIG. 3 illustrates an example network in accordance with some example embodiments of the invention;

FIG. 4 illustrates an example user interface display in accordance with some example embodiments of the invention;

FIG. 5 illustrates another example user interface display in accordance with some example embodiments of the invention;

FIG. 6 illustrates an example of a building and a sector a wall-mounted antenna may typically handle;

FIG. 7 illustrates some examples of angles from each wall to a base station of a rectangular shape house;

FIG. 8 illustrates an example of bird's-eye view when a user equipment is clicked against the wall in accordance with some example embodiments of the invention.

FIG. 9 illustrates an example of detecting a click using an accelerometer in accordance with some example embodiments of the invention;

FIG. 10 illustrates an example of bird's-eye view of a device with directional antenna clicked against the wall in accordance with some example embodiments of the invention; and

FIG. 11 illustrates a block diagram of a user equipment in accordance with some example embodiments.

### DETAILED DESCRIPTION OF THE DRAWINGS

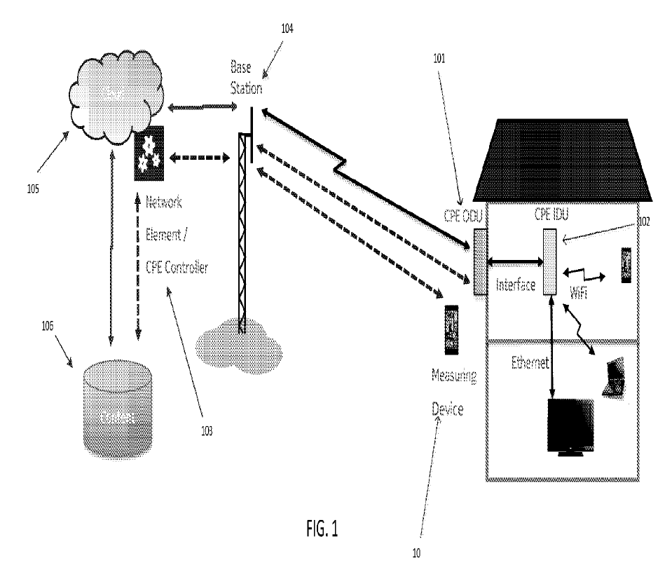

The subject matter disclosed herein provides a way for finding out a location to install a device with directional antenna, such as a CPE or an outdoor unit (ODU) as illustrated in FIG. 1, in some high data rate or capacity systems such as Long Term Evolution (LTE). Specifically, there is provided a way of finding out a location to install a device with directional antenna by using a measuring device, such as a smartphone, and a software program, such as an application. Although some of the examples refer to LTE, the subject matter disclosed herein may be used in other wireless systems as well.

FIG. 1 illustrates an example network in which some example embodiments of the present invention may be practiced. As illustrated in FIG. 1, in the network, an outdoor unit (ODU) 101, for example, of a CPE, is connected with a base station 104 of a network using wireless protocols, for example, LTE. The ODU 101 may use directional antenna. The ODU 101 may connect to an indoor unit (IDU) 102 via wire, such as a cable, or wirelessly with an interface. The IDU 102 may communicate with end user devices via short range radio communications, for example, WiFi or Bluetooth radio. The network may have dedicated frequency bands and capacity allocated for the fixed wireless broadband use by CPE. The base station 104 may fetch content 106 through cloud services 105 operated by operators. Content 106 may include end user services, for example, internet content that is provided through the cloud and the operator network to the end users. Content 106 may also include network management information, such as radio network capacity management, CPE control and performance optimization information, that a network element, such as network element/CPE controller 103, is using to manage the ODU 101 and IDU 102. A measuring device 10, such as a smartphone, communicates with base station 104 using wireless protocols, for example, LTE. The measuring device 10 may communicate with ODU 101, for example, via short range radio communications. It is noted that the measuring device 10 may be ODU 101, for example, CPE itself.

Although FIG. 1 illustrates a certain quantity and configuration of devices, other quantities and configurations may be implemented as well. For example, other quantities and configurations of base stations/access points, ODU and IDU, and end user devices may be implemented as well.

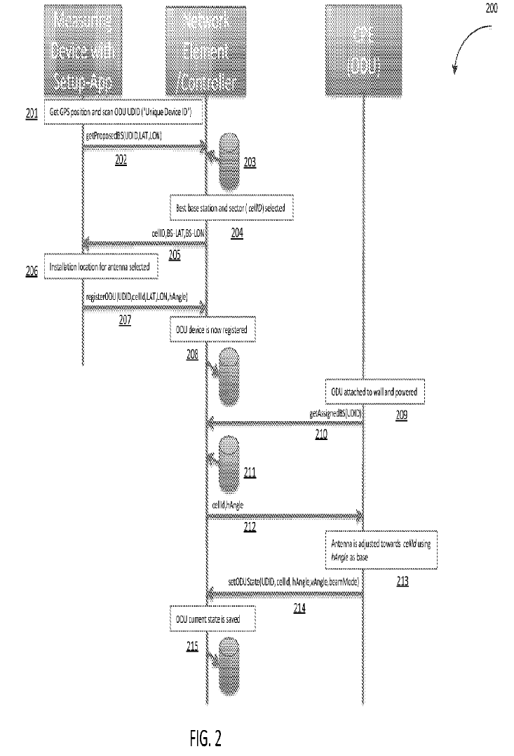

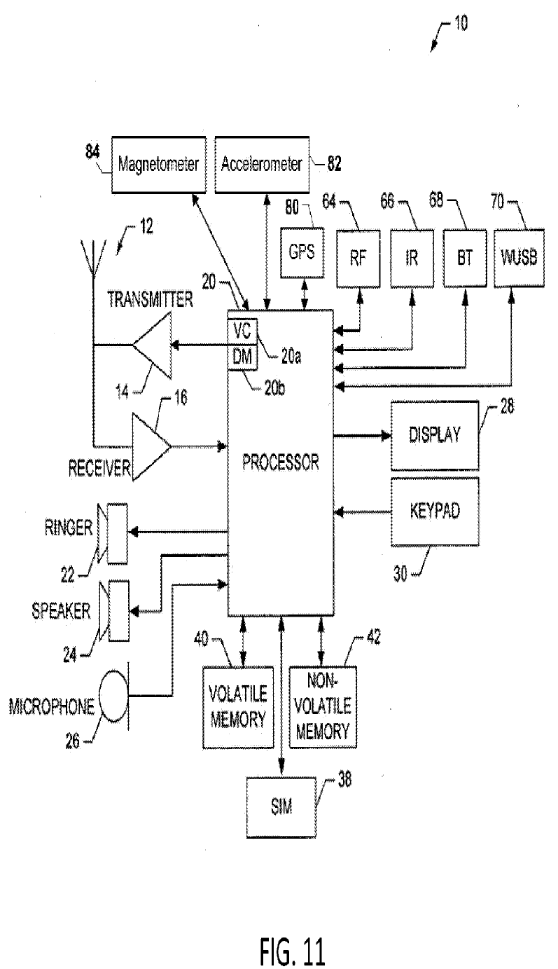

FIG. 2 illustrates an example process for installing a device with directional antenna in accordance with some example embodiments. The example process 200 may be performed by a measuring device, such as the measuring device 10 of FIG. 1 and the apparatus 10 of FIG. 11. It is noted that the example process 200 may be performed by a CPE with the same or simplified components as the apparatus 10 of FIG. 11. For example, the display of the CPE may be a black-and-white matrix display or a LED array, which is capable of showing an arrow for direction.

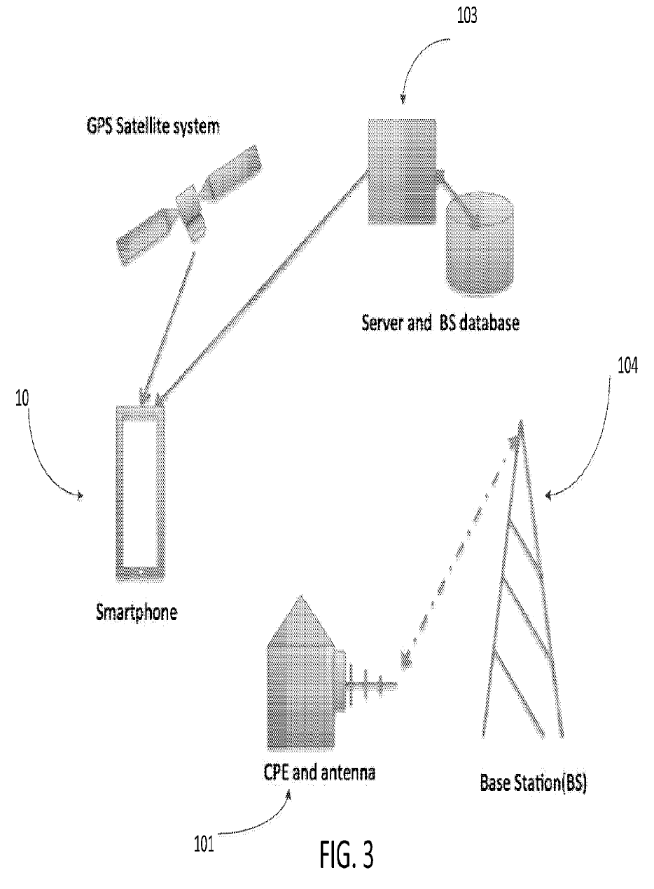

FIG. 3 illustrates an example network in accordance with some example embodiments of the invention. According to some example embodiments, an application is installed to a measuring device 10, such as the measuring device 10 of FIG. 1 and the apparatus 10 of FIG. 11. The application acquires the current location geo-coordinates, for example, by using Global Positioning System (GPS). After acquiring the current location, the measuring device 10 establishes a connection, such as an IP connection, to network element 103, such as a server or a CPE controller.

Referring back to FIG. 2, at 201, the measuring device acquires current location geo-coordinates, for example, by using GPS. The measuring device may retrieve a unique device identifier (UDID) of CPE 101 by, for example, a bar code or a quick response (QR) code that contains the UDID information. At 202, the measuring device sends a message which may include the acquired current location and UDID to network element 103. At 203, the network element stores the received location and UDID information. At 204, the network element selects one or more candidate base station(s)/sector(s) based on the received location information from the measuring device. For example, the network element may select a base station/sector with the closest distance or lowest path loss to the measuring device. In another example, the network element may select a base station/sector with capacity allocated to the CPE for the wireless broadband service in the usage location. At 205, the network element sends information associated with the at least one candidate base station to the measuring device. The information may include, for example, cell identity of the candidate base station(s)/sectors(s), location coordinates of the candidate base station(s). The network element may receive the cell identity and coordinates of the candidate base station(s) from another network entity which has pre-defined information of the candidate base station(s) allocated to each CPE.

At 206, the measuring device assists in selecting a surface location for antenna installation. A surface location may be different kind, for example, point, dot, plane, wall, part of a wall, pole, rod, rail etc. Using a magnetometer, the application installed to the measuring device may show the direction towards one candidate base station.

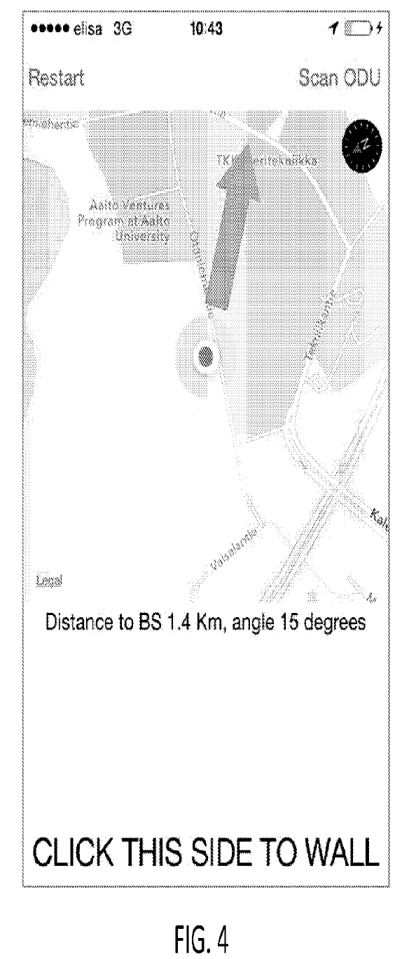

When the measuring device is held horizontally, for example, bottom-down, the application shows street map and an arrow towards the candidate base station. FIG. 4 illustrates an example user interface display in accordance with some example embodiments of the invention. In some example embodiments, the arrow color may be used to indicate the quality of connection between the locations of the measuring device and a base station. For example, the arrow color is green when the direction to the base station is good, in which case the user equipment long axis points to a direction that deviates from the direction of the base station within certain degrees, such as, max +−45 degrees; the arrow color is yellow when the direction is mediocre, in which case the deviation is larger, e.g., +−60 degrees, and red when the deviation is more. The target at this stage of installation process is to identify the best installation wall candidates, for example, when walking in the yard of a house, and thus this kind of relatively rough visual indication for the right direction is adequate and convenient from the installation person's point of view.

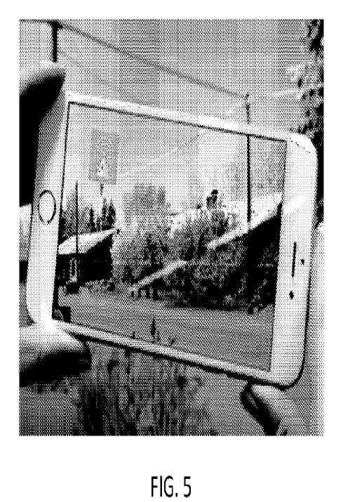

When the user equipment is held vertically, for example, edge up, the application shows augmented landscape on the user interface. FIG. 5 illustrates another example user interface display in accordance with some example embodiments of the invention. With the landscape view, one can easily detects objects, such as buildings and mountains which attenuate the signal, that are between the installation location and a base station.

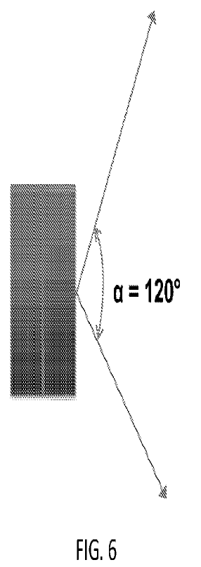

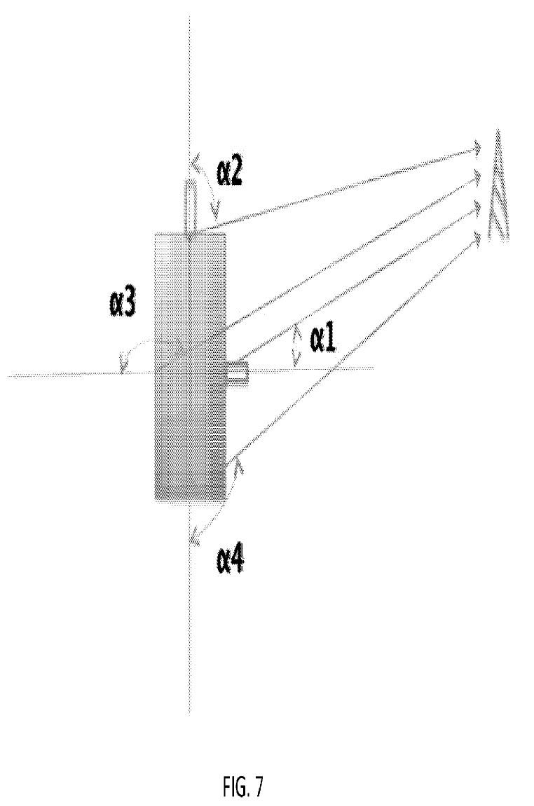

According to some example embodiments, a device with directional antenna is installed on a wall of a house. A manually steerable antenna has limits in the angle it can be tilted, a beamforming antenna also has it limits in the tuning range. Typically a wall-mounted antenna may be adjusted to handle a sector of certain degrees, for example, 120 degrees, in horizontal direction. FIG. 6 illustrates an example of a building and a sector a wall-mounted antenna may typically handle. Depending on the shape of a house, for example, for a rectangle or square shapes of house, usually maximum two walls are suitable for the wall attachment of a directional antenna. The angle between the wall normal and the direction of the base station of interest is recommended from zero to +−90 degrees because with over 90 degrees the wall starts to block the direct view to the base station. FIG. 7 illustrates some examples of angles from each wall to a base station of a rectangular shape house. As can be seen from FIG. 7, only two walls with angles of α1 and α2 are potential for the antenna attachment, because angles α3 and α4 are more than 90 degrees in which case wall is starting to block the direct signal from/to the base station.

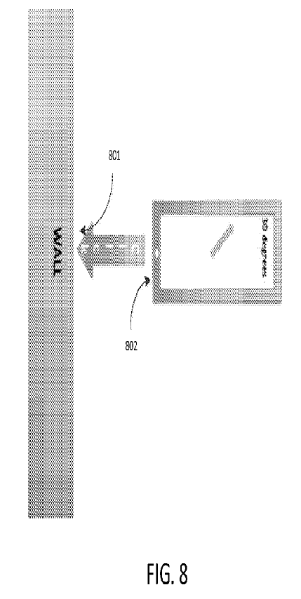

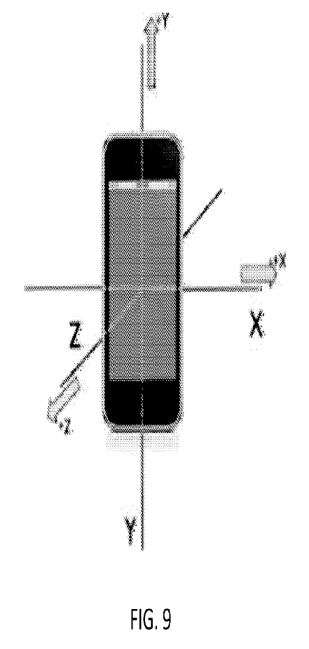

Referring back to FIG. 2, the measuring device is set towards one or more location(s) of one or more potential walls with the same edge of the measuring device and perform measurement on the one or more locations. By using, for example, an accelerometer, a pressure sensor, a touch sensor, a magnetometer, a compass, a gyro, a proximity sensor, a barometer, or a combination thereof, the measuring device may detect a click and this activates a measurement event. FIG. 8 illustrates an example of bird's-eye view when the measuring device, for example, in a horizontal direction with the bottom edge 802 against the wall, is clicked against the wall 801 in accordance with some example embodiments of the invention. FIG. 9 illustrates an example of detecting a click by measuring device acceleration in X, Y and Z-axis using an accelerometer in accordance with some example embodiments of the invention. When the measuring device is clicked against the wall, for example, as in FIG. 8, the measured acceleration (“g-force”) along one axis, for example, in the Y-axis, is sharply increased and immediately decreased.

The measurement event triggered by detecting a clicking may activate measurement of an angle provided by a magnetometer, the angle is defined as the direction between measured wall location normal direction and location of a candidate base station. The measurement event triggered by detecting a clicking may activate measurement of radio connectivity, such as signal strength, from a candidate base station. In case a hole needs to be drilled to the wall for a cable through the wall, the application on the measuring device may be used to analyze the depth and material of the wall by analyzing, for example, the sound (echo sounding) generated by the click. For example, wood generates a different sound than brick and thinner wall also generates a different sound compared to a thick wall. Different walls may have differences in terms of measurement results, and also different locations on the same wall may have differences in terms of measurement results. Therefore, measurements may be repeated in various locations of potential walls. The process may also be repeated for all the candidate base station(s).

It is noted that each measurement may not have to include the same set of measurement parameters. For example, in one or more embodiments measurement in surface location #1 may include an angle measurement only, surface location #2 may include an angle and radio connectivity and wall material measurements, surface location #3 may include an angle and radio connectivity measurement. It is also noted that measurement for each candidate base stations may not have to be the same kind. For example, in one or more embodiments measurement for base station #1 may not include the same surface locations as measured for base station #2. In another example, in one or more embodiments the surface locations measured for base station #1 may not include the same set of measurement parameters as the surface locations measured for base station #2.

The application on the measuring device may analyze and display on the user interface the measurement results. For example, Table 1 shows an example of measurement results for three measurement events. In the example, the three measurement events have the same set of measurement parameters, that is, they all have measurement on angle, signal strength, and wall materials.

TABLE 1
Measurement results for three measurement events

| Measure- | | | | |
|---|---|---|---|---|
| ment | | Signal | Coordinate LAT/LONG | Wall |
| # | Angle | strength | (N/E) | material |
| 1 | 40 | Fair | 60.18696667/24.81725 | Thick |
| 2 | 15 | Excellent | 60.18756667/24.81403333 | Thin |
| 3 | 15 | Excellent | 60.1873/24.81385 | Thick |

The measuring device selects the location with the best measurement results based on certain criteria. The criteria for selecting the best wall and the exact location for the device with directional antenna installation may be defined by the application. For example, the best location may be the location with the smallest angle toward a candidate base station, or the location with the strongest signal strength, or the location with the thinnest wall material, or a combination of some or all these factors. Referring to Table 1, measurement events #2 and #3 have smaller angle and stronger signal strength than event #1. Since the wall material is thinner in event #2 than #3, the location as measured in event #2 is selected to install the directional antenna device. A specific color may be used to indicate the selected location.

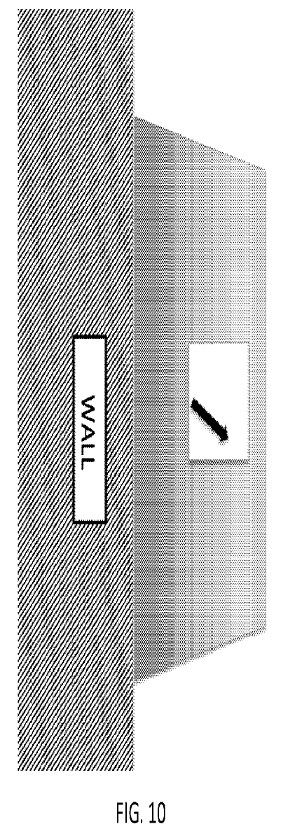

FIG. 10 illustrates an example of bird's-eye view of a device with directional antenna clicked against the wall in accordance with some example embodiments of the invention. As seen from FIG. 10, the shape of the device indicates the edge that is attached to the wall. The arrow indicates the direction towards the selected base station and may be implemented with, for example, a matrix display. The device may have some or all the components as illustrated in FIG. 11. For example, the device may have memory to store measurement results, and a processor to process measurement results. The device may comprise a GPS receiver, for receiving location information. The device may also comprise an accelerometer for measuring device acceleration. The device may further comprise a magnetometer, for example, for measuring direction of magnetic field at the location of the device. The device may have simplified components as the apparatus 10 of FIG. 11. For example, the display of the device may be a black-and-white matrix display or a LED array, which is capable of showing an arrow for direction.

In some example embodiments, when a user is confirming the selection provided by the application, the user interface of the measuring device may guide the user to the best measured installation location, for example, showing direction and/or distance. The user may also select another option from the list of measurement results. In some other example embodiments, the user is not shown measurement results but instead, the application may guide the user to the best installation location selected by the application. In one example embodiment, the user of the measuring device marks the measurement locations in numbers 1, 2, 3, . . . etc. to depict the measurement point and marks it on the respective wall point, so that user can find the right point afterwards. The user interface in the measuring device may also provide an input field after the click to add the respective number or accept the number in the user interface to link the measurement results to that number. Later user can get back to the number to be used as the point where the device with directional antenna is recommended to be installed based on the analysis of measurement results. In one example embodiment only one measurement result is needed, for example, in situations where based on analysis of the one the measurement result the service would be assessed to be in an acceptable level, the criteria being, for example, based on the past measurement results and use of services reflecting acceptable quality of services.

In an example embodiment the user interface comprises representations of locations of a base station, a measuring device, respective location of the surface location (touch point) and based on them a line at least between the base station and the selected surface location taking into consideration measurement results from angle measurements, radio connectivity measurements, such as signal strength, or depth and materials of the wall measurement, like wall insulation, thickness, etc. One or more results may be evaluated and used in determination of the surface location where the CPE could be installed. CPE may have in addition an antenna controller to be used to turn the antenna to the best direction to get the best performance. It is noted that selection of surface location includes selection of a surface location where the device with directional antenna, such as CPE, is installed after the measurement process and final location selection, selection of surface location also includes selection of a surface, such as which wall that is roughly selected before detailed measurements are taking place to determine the exact surface location for the device with directional antenna device installation.

Referring back to FIG. 2, after the location of installation is selected, at 207, the measuring device may send a message to network element. The message may include an identity, such as UDID, of the device with directional antenna, for example the device 101 of FIG. 1, and cell ID of the selected base station. The message may also include information associated with the angle between the defined installation wall normal and the direction of the selected base station. The message may further include the location of installation. After receiving the message, at 208, the network element registers the device. At 209, the device with directional antenna is attached to the selected wall location and is powered on.

In some example embodiments, the device with directional antenna, using its own identity such as UDID as an identifier, may fetch from network element initial tuning direction towards the selected base station. This way the antenna can be directed to the selected base station faster than with scanning the full field-of-view. The antenna may then start fine-tuning the direction to the optimal angle. For example, at 210, the device sends a message to the network element, the message includes an identity of the device, such as UDID. At 211, the network element receives the message, and in response to the received message, at 212, the network element sends a message back to device. The message may include the cell ID of the selected base station. The message may also include information associated with the angle between the defined installation wall normal and the direction of the selected base station.

In some other example embodiments, the measuring device delivers the cell ID of the selected base station and antenna tuning angle information directly to the device with the directional antenna. This may be done through local wireless or wired connection between the measuring device and the directional antenna device.

At 213, the antenna of the device is adjusted towards the selected base station with the received cell ID and using the received information associated with angle as a base for the adjustment. Then at 214, the device sends a message to the network element. The message may include an identity of the device such as UDID and cell ID of the selected base station. The message may also include the received angle information from the network element and adjusted angle towards the selected base station. The message may further include beam mode information. In some example embodiments, beam mode includes ‘narrow beam’, for example, ‘directional beam’, and a ‘wide beam’, for example, 120 degree beam. At 215, the network element receives the message and saves the current state of the device.

FIG. 11 illustrates a block diagram of an apparatus 10, in accordance with some example embodiments. The apparatus 10 (or portions thereof) may be configured to provide a user equipment, a communicator, a machine type communication device, a wireless device, a wearable device, a smartphone, a cellular phone, a wireless sensor/device (for example, a wireless device which is part of a distributed architecture in for example, a car, a vehicle, a robot, a human, and/or the like). In the case of the distributed architecture, the wireless device may communicate via one or more transceiver modules and/or via a hub that may hide the actual distribution of functionalities from the network.

The apparatus 10 may include at least one antenna 12 in communication with a transmitter 14 and a receiver 16. Alternatively transmit and receive antennas may be separate.

The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise processor 20 may be configured to control other elements of apparatus 10 by effecting control signaling via electrical leads connecting processor 20 to the other elements, such as for example a display or a memory. The processor 20 may, for example, be embodied as various means including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit, ASIC, or field programmable gate array (FPGA), and/or the like) or some combination thereof. Accordingly, although illustrated in FIG. 11 as a single processor, in some embodiments the processor 20 comprises a plurality of processors or processing cores.

Signals sent and received by the processor 20 may include signaling information in accordance with an air interface standard of an applicable cellular system, and/or any number of different wireline or wireless networking techniques, comprising but not limited to Wi-Fi, wireless local access network, WLAN, techniques such as Institute of Electrical and Electronics Engineers, IEEE, 802.11, 802.16, and/or the like. In addition, these signals may include speech data, user generated data, user requested data, and/or the like.

The apparatus 10 may be capable of operating with one or more air interface standards, communication protocols, modulation types, access types, and/or the like. More particularly, the apparatus may be capable of operating in accordance with various first generation, 1G, second generation, 2G, 2.5G, third-generation, 3G, communication protocols, fourth-generation, 4G, communication protocols, Internet Protocol Multimedia Subsystem, IMS, communication protocols, for example, session initiation protocol, SIP, and/or the like. For example, the apparatus may be capable of operating in accordance with 2G wireless communication protocols IS-136, Time Division Multiple Access TDMA, Global System for Mobile communications, GSM, IS-95, Code Division Multiple Access, CDMA, and/or the like. Also, for example, the apparatus 10 may be capable of operating in accordance with 2.5G wireless communication protocols General Packet Radio Service. GPRS, Enhanced Data GSM Environment, EDGE, and/or the like. Further, for example, the apparatus may be capable of operating in accordance with 3G wireless communication protocols such as Universal Mobile Telecommunications System, UMTS, Code Division Multiple Access 2000, CDMA2000, Wideband Code Division Multiple Access, WCDMA, Time Division-Synchronous Code Division Multiple Access, TD-SCDMA, and/or the like. The apparatus may be additionally capable of operating in accordance with 3.9G wireless communication protocols such as Long Term Evolution, LTE, or Evolved Universal Terrestrial Radio Access Network, E-UTRAN, and/or the like. Additionally, for example, the apparatus may be capable of operating in accordance with fourth-generation, 4G, wireless communication protocols such as LTE Advanced and/or the like as well as similar wireless communication protocols that may be subsequently developed.

It is understood that the processor 20 may comprise circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor may additionally comprise an internal voice coder, VC, 20a, an internal data modem, DM, 20b, and/or the like. Further, the processor may comprise functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the apparatus 10 to transmit and receive web content, such as location-based content, according to a protocol, such as wireless application protocol, WAP, hypertext transfer protocol, HTTP, and/or the like

Apparatus 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. Although not shown, the apparatus 10 may comprise a battery for powering various circuits related to the apparatus, for example, a circuit to provide mechanical vibration as a detectable output. The user input interface may comprise devices allowing the apparatus to receive data, such as a keypad 30, a touch display, which is not shown, a joystick, which is not shown, and/or at least one other input device. In embodiments including a keypad, the keypad may comprise numeric 0-9 and related keys, and/or other keys for operating the apparatus.

As shown in FIG. 11, apparatus 10 may also include one or more mechanisms for sharing and/or obtaining data. For example, the apparatus may comprise a short-range radio frequency, RF, transceiver and/or interrogator 64, so data may be shared with and/or obtained from electronic devices in accordance with RF techniques. The apparatus may comprise other short-range transceivers, such as an infrared (IR) transceiver 66, a Bluetooth™ (BT) transceiver 68 operating using Bluetooth™ wireless technology, a wireless universal serial bus (USB) transceiver 70, a Bluetooth™ Low Energy transceiver, a ZigBee transceiver, an ANT transceiver, a cellular device-to-device transceiver, a wireless local area link transceiver, and/or any other short-range radio technology. Apparatus 10 and, in particular, the short-range transceiver may be capable of transmitting data to and/or receiving data from electronic devices within the proximity of the apparatus, such as within 10 meters, for example. The apparatus 10 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise a memory, such as a subscriber identity module, SIM, 38, a removable user identity module, R-UIM, and/or the like, which may store information elements related to a mobile subscriber. In addition to the SIM, the apparatus may comprise other removable and/or fixed memory. The apparatus 10 may include volatile memory 40 and/or non-volatile memory 42. For example, volatile memory 40 may include Random Access Memory, RAM, including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, etc., optical disc drives and/or media, non-volatile random access memory, NVRAM, and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing functions of the user equipment. The memories may comprise an identifier, such as for example, an international mobile equipment identification (IMEI) code, capable of uniquely identifying apparatus 10. In the example embodiment, the processor 20 may be configured using computer code stored at memory 40 and/or 42 to control and/or provide one or more aspects disclosed herein with respect to process 200 including for example receiving information associated with location of at least one candidate base station from a server.

The apparatus 10 may comprise a GPS receiver, for receiving location information of the apparatus. The apparatus 10 may also comprise an accelerometer for measuring device acceleration. The apparatus 10 may further comprise a magnetometer, for example, for measuring direction of magnetic field at the location of the apparatus.

Without in any way limiting the scope, interpretation, or application of the claims appearing below, a technical effect of one or more of the example embodiments disclosed herein may include enabling installation of a device with directional antenna.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims. Other embodiments may be within the scope of the following claims. The term “based on” includes “based at least in part on”. The use of the phase “such as” means “such as for example” unless otherwise indicated.

1-44. (canceled)

45. A method, comprising:
causing an angle of a measuring device towards at least one base station to be measured when the measuring device is set from one edge against a surface location,
wherein the angle is used to determine surface location for an antenna installation.

46. The method of claim 45, further comprising:
receiving by the measuring device information associated with a location of the at least one base station from a network element.

47. The method of claim 46, wherein the information associated with the location of the at least one base station comprises at least one of: information associated with location of a base station that has the best radio connectivity to the measuring device, and information associated with location of a base station that has planned capacity in the location of the measuring device.

48. The method of claim 46, wherein the information associated with the location of the at least one base station comprises a cell identity and location coordinates of the at least one base station.

49. The method of claim 45, wherein determining the surface location for the antenna installation comprises a wall selection.

50. The method of claim 45, wherein determining the surface location for the antenna installation is based on at least one of: the measured angle, a measured radio connectivity, measured depth and materials of the surface location.

51. The method of claim 45, further comprising: when the measuring device is held horizontally with bottom down, displaying a street map and an arrow towards the at least one base station on the measuring device.

52. The method of claim 45, further comprising: indicating quality of direction towards the at least one base station by arrow color.

53. The method of claim 45, further comprising: when the measuring device is held vertically with edge up, displaying an augmented landscape on the measuring device.

54. An apparatus, comprising:
at least one processor; and
at least one memory including computer program code,
wherein the at least one memory and the computer program code are configured to, with the at least one processor, cause the apparatus to perform at least the following:
cause an angle of the apparatus towards at least one base station to be measured when the apparatus is set from one edge against a surface location, wherein the angle is used to determine surface location for an antenna installation.

55. The apparatus of claim 54, wherein the apparatus is further caused to:
receive information associated with a location of the at least one base station from a network element.

56. The apparatus of claim 55, wherein the information associated with the location of the at least one base station comprises at least one of: information associated with location of a base station that has the best radio connectivity to the apparatus, and information associated with location of a base station that has planned capacity in the location of the apparatus.

57. The apparatus of claim 55, wherein the information associated with the location of the at least one base station comprises a cell identity and location coordinates of the at least one base station.

58. The apparatus of claim 54, wherein determining the surface location for the antenna installation comprises a wall selection.

59. The apparatus of claim 54, wherein determining the surface location for the antenna installation is based on at least one of: the measured angle, a measured radio connectivity, measured depth and materials of the surface location.

60. The apparatus of claim 54, wherein the apparatus is further caused to: when the apparatus is held horizontally with bottom down, display a street map and an arrow towards the base station.

61. The apparatus of claim 54, wherein the apparatus is further caused to: indicate quality of direction towards the at least one base station by arrow color.

62. The apparatus of claim 54, wherein the apparatus is further caused to: when the apparatus is held vertically with edge up, display an augmented landscape.

63. The apparatus of claim 54, further comprising: detecting that the one edge of the apparatus is against the surface location, wherein detecting that the one edge of the measuring device is against the surface location comprises sensing by: an accelerometer, a magnetometer, a compass, a pressure sensor, a touch sensor, a gyro, a proximity sensor, a barometer, or a combination thereof.

64. The apparatus of claim 54, wherein the apparatus is a mobile device or a customer premises equipment.
